(19) United States
(12) Patent Application Publication
(10) Pub. No.: US 2026/0295961 A1
(43) Pub. Date: Oct. 1, 2026

(54) WEDGE PRESS

(71) Applicant: Prime Solution, Inc., Otsego, MI (US)

(72) Inventors: Joseph W. DENDEL, Allegan, MI (US); Dominick R. GORANG, Kalamazoo, MI (US); Kyle S. PARLIAMENT, Wayland, MI (US)

(21) Appl. No.: 19/097,285

(22) Filed: Apr. 1, 2025

(51) Int. Cl. B30B 9/20; B01D 33/21; B30B 3/02; B30B 9/26

(52) U.S. Cl. CPC B30B 9/20; B30B 3/02; B30B 9/26; B01D 33/21

(57) ABSTRACT

A liquid extraction assembly for extracting liquid from a mass comprising a housing having an inlet, an outlet and a path between the inlet and the outlet. Mass is forced into the inlet and moves from the inlet to the outlet. The housing includes a pair of separately rotatable non-parallel screens adjacent opposite sides of the path, the pair of rotating screens defining opposite walls of the path. The pair of rotating screens including a plurality of openings located at the path and pressure from the mass forced into the inlet presses the mass against the openings of the pair of rotating screens to thereby force at least a portion of liquid in the mass to pass through the openings of the pair of rotating screens. A cross-sectional area of the path between the pair of rotating screens is larger adjacent the inlet than adjacent the outlet.

### FIELD OF THE INVENTION

The present invention concerns a liquid extraction machine, and more particularly relates to liquid extraction machines having a wedge press.

### BACKGROUND OF THE INVENTION

Apparatus for feeding, compressing, liquid extraction, washing and chemical treatment of sludge, slurries or other wet materials are well known. Such equipment finds particular application in the pulp and paper industry, waste water treatment, mineral processing, agriculture, food processing, fisheries, breweries, wineries, chemical processing, oil and tar sands industry, etc. This apparatus is referred to as a liquid extraction machine.

Prior art liquid extraction machines include the liquid extraction machines disclosed in U.S. Pat. No. 10,391,728, the entire contents of which are incorporated herein by reference. Such prior art liquid extraction machines include an inlet pipe for supplying a humid mass (e.g., sludges and slurries), as those used or produced in the pulp and paper industry, waste water treatment plants, agricultural, food and beverage industries, etc., to the liquid extraction machine. The humid mass is forced through the liquid extraction machine and at least a portion of the liquid from the humid mass forced through the liquid extraction machine is forced under pressure through filter screens positioned on opposite sides of the path of the humid mass passing through the machine, to result in a cake portion of the humid mass with at least a portion of the liquid previously therein removed and a liquid filtrate portion. The liquid extraction machine then outputs the cake portion through an opening at the end of the path through the liquid extraction machine and the liquid filtrate portion through a filtrate outlet fluidly connected to area outside of the path and the filter screens.

An improved apparatus is desired for removing the liquid portion from the humid mass of the prior art liquid extraction machine.

### SUMMARY OF THE INVENTION

An aspect of the present invention is to provide a liquid extraction assembly for extracting liquid from a mass comprising a housing having an inlet and an outlet, with the housing further including a path between the inlet and the outlet. The housing is configured to have the mass forced into the inlet to move the mass from the inlet to the outlet. The housing includes a pair of rotating screens adjacent opposite sides of the path, with the pair of rotating screens defining opposite walls of the path.

The pair of rotating screens include a plurality of openings located at the path. Pressure from the mass forced into the inlet presses the mass against the openings of the pair of rotating screens to thereby force at least a portion of liquid in the mass to pass through the openings of the pair of rotating screens. The pair of rotating screens are non-parallel such that a cross-sectional area of the path between the pair of rotating screens is larger adjacent the inlet than adjacent the outlet.

Another aspect of the present invention is to provide a method of extracting liquid from a mass comprising providing a housing having an inlet and an outlet, providing a path between the inlet and the outlet, forcing the mass into the inlet of the housing to move the mass from the inlet to the outlet, providing the housing with a pair of rotating screens adjacent the path, with the pair of rotating screens defining opposite walls of the path, with the pair of rotating screens including a plurality of openings located at the path, rotating the pair of rotating screens, pressing the mass against the openings of the pair of rotating screens to thereby force at least a portion of liquid in the mass to pass through the openings of the pair of rotating screens, and positioning the pair of rotating screens non-parallel to each other such that a cross-sectional area of the path between the pair of rotating screens is larger adjacent the inlet than adjacent the outlet.

Yet another aspect of the present invention is to provide a liquid extraction assembly for extracting liquid from a mass comprising a housing having an inlet and an outlet, with the housing further including a path between the inlet and the outlet. The housing is configured to have the mass forced into the inlet to move the mass from the inlet to the outlet. The housing includes a pair of rotating screens adjacent opposite sides of the path, with the pair of rotating screens defining opposite walls of the path. The pair of rotating screens include a plurality of openings located at the path. Pressure from the mass forced into the inlet presses the mass against the openings of the pair of rotating screens to thereby force at least a portion of liquid in the mass to pass through the openings of the pair of rotating screens. Each of the pair of rotating screens has a separate motor assembly for rotating one of the pair of rotating screens associated therewith such that each of the pair of rotating screens can rotate at a different speed.

### BRIEF DESCRIPTION OF DRAWINGS

FIG. 1 is a perspective view of a liquid extraction machine of the present invention.

FIG. 2 is an exploded view of the liquid extraction machine of the present invention.

FIG. 3 is a side view of the liquid extraction machine of the present invention.

FIG. 4 is a top view of the liquid extraction machine of the present invention.

FIG. 5 is a perspective view of a wedge press of the liquid extraction machine of the present invention.

FIG. 6 is a front view of the wedge press of the liquid extraction machine of the present invention.

FIG. 7 is an exploded perspective view of the wedge press of the liquid extraction machine of the present invention.

FIG. 8 is an exploded front view of the wedge press of the liquid extraction machine of the present invention.

FIG. 9 is a close up view of a retaining plate, an outer seal and a wheel assembly of the wedge press of the liquid extraction machine of the present invention.

### DETAILED DESCRIPTION OF PREFERRED EMBODIMENTS

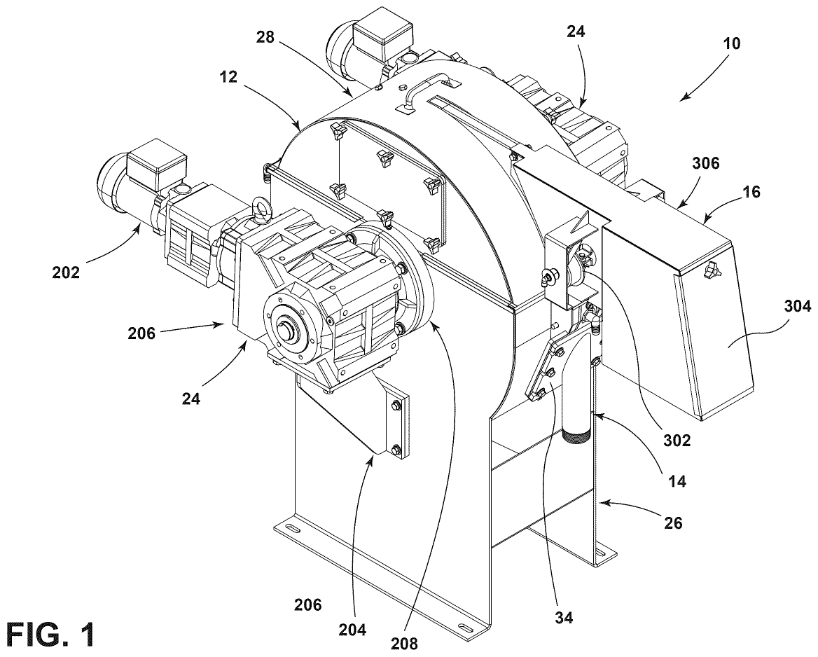

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless expressly stated otherwise.

The present invention relates to an apparatus and method for extracting liquid from a humid mass (e.g., sludges and slurries), as those used or produced in the pulp and paper industry, waste water treatment plants, agricultural, food and beverage industries, etc. The apparatus and method according to the present invention operate on the same basic extraction principle as the system and method described in U.S. Pat. No. 4,534,868, the disclosure of which is hereby incorporated herein by reference. The present invention is used to remove a portion of liquid from the humid mass to produce a waste solid that is easy to dispose. U.S. Pat. No. 10,391,728, the entire contents of which are incorporated herein by reference, also discloses further general principles of using the liquid extraction machine of the present invention.

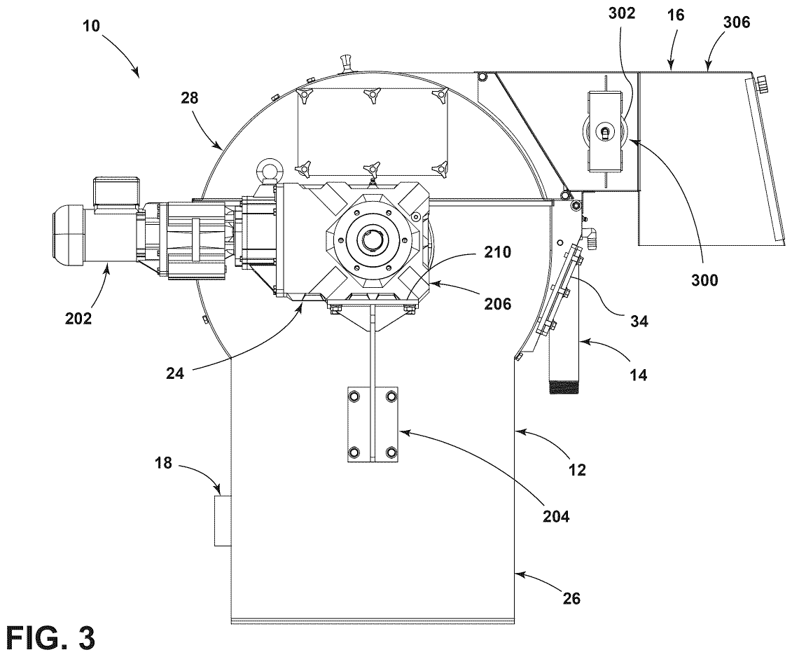

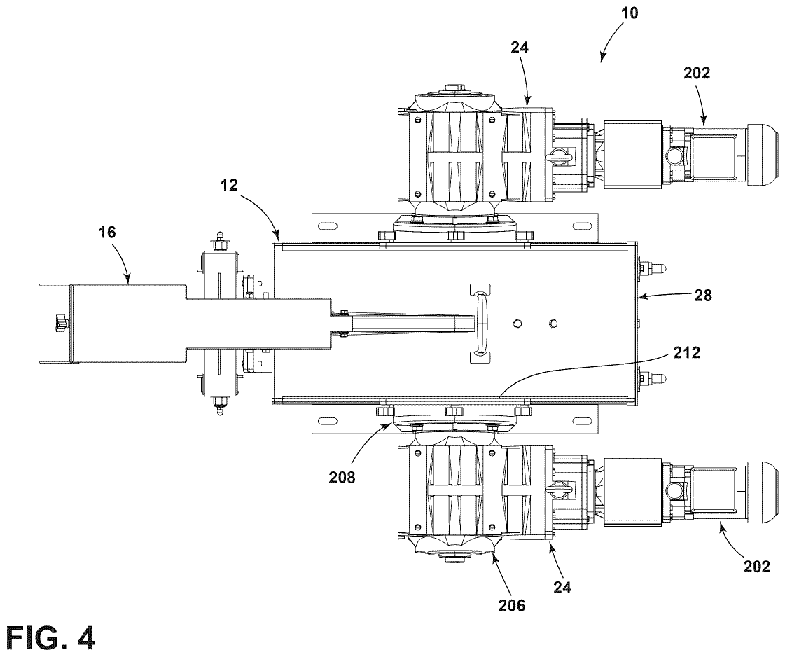

The reference number 10 (FIGS. 1-4) generally designates a liquid extraction machine according to the present invention. The liquid extraction machine 10 includes a housing 12 having an inlet pipe 14 for forcing the humid mass under pressure into and through the housing 12, a cake discharge unit 16 wherein the waste solid or solid cake (i.e., a portion of the humid mass with at least a portion of the liquid thereof removed therefrom) is output from the housing 12 and the liquid extraction machine 10, and a filtrate discharge 18 for outputting the liquid removed from the humid mass or liquid filtrate from the housing 12 and the liquid extraction machine 10. As stated herein, the liquid extraction machine 10 according to the present invention operates on the same basic extraction principle as prior art systems. However, the liquid extraction machine 10 according to the present invention includes a wedge press 20 having a pair of filter screens 22 that are non-parallel (i.e., have axes of rotation that are not parallel or colinear) along with at least one motor assembly 24 for rotating the non-parallel pair of filter screens 22.

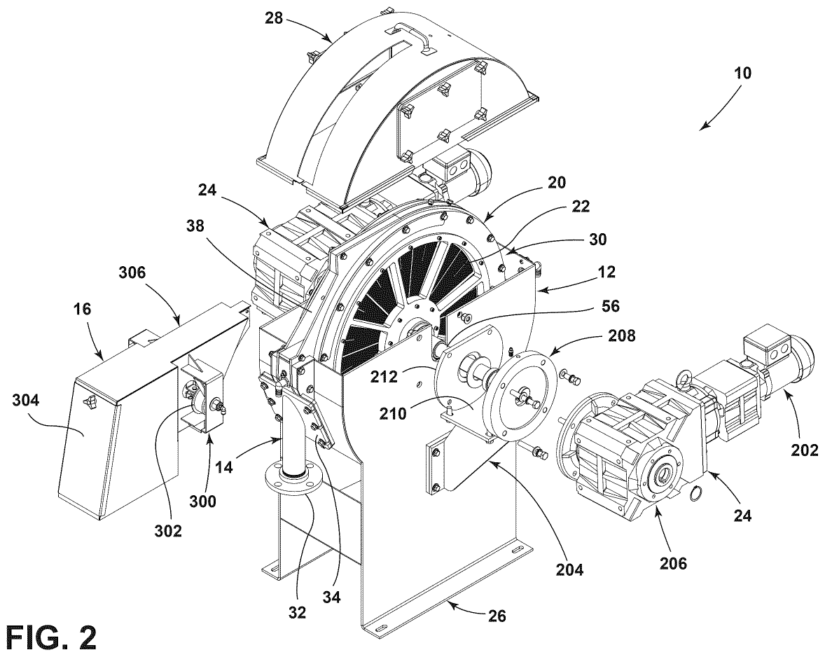

In the illustrated example, the housing 12 of the liquid extraction machine 10 holds and supports the elements of the liquid extraction machine 10. The housing 12 includes a base 26 configured to be positioned on a support surface (e.g., a movable sled, a trailer or fixed to a floor of a building). The housing 12 further includes a cover 28 connected to the base 26. The base 26 and the cover 28 define an interior space 30 of the housing 12, with the wedge press 20 being located within the interior space 30 of the housing 12 as described in further detail herein (see FIG. 2). However, it is contemplated that the housing 12 could include any structure that houses the wedge press 20 therein (e.g., a pair of clam shell structures that each includes a portion of the base 26 and a portion of the cover 28).

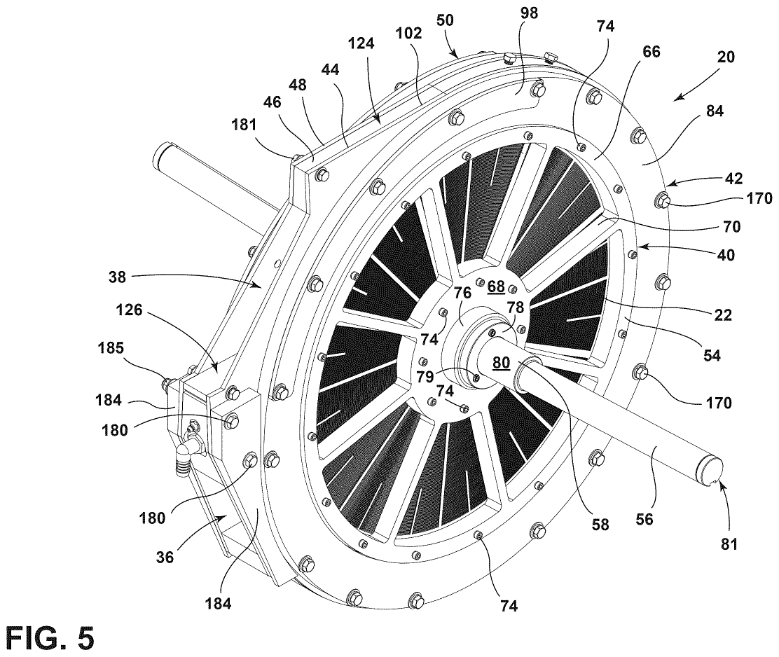

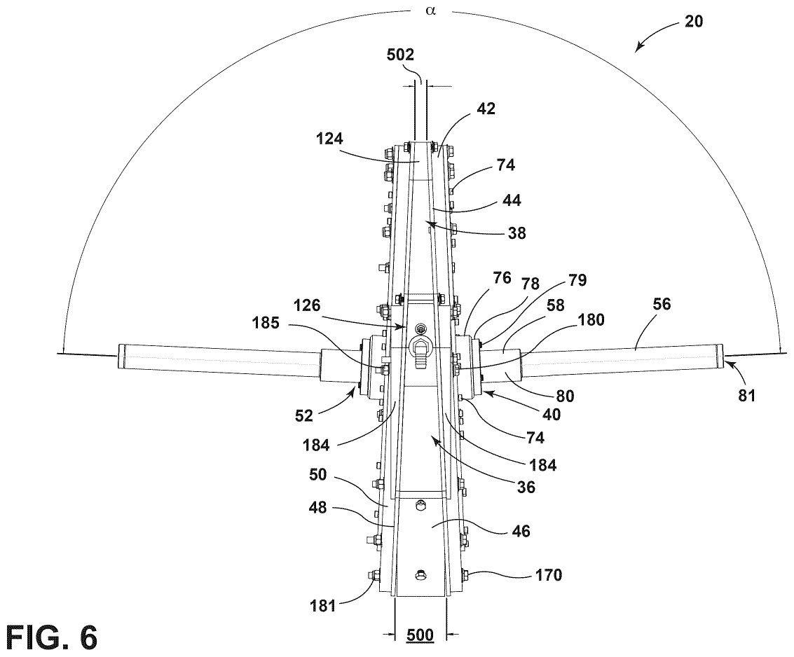

The illustrated inlet pipe 14 supplies the humid mass to the interior space 30 of the housing 12. In the illustrated embodiment, the inlet pipe 14 includes a mounting plate 34 for connecting the inlet pipe 14 to the base 26 and can include a connection flange 32 for connection to a supply of humid mass (as shown in FIG. 2). The humid mass enters the housing 12 through the inlet pipe 14, then enters the wedge press 20 in the interior space 30 of the housing 12 through a wedge press inlet 36 (see FIGS. 5 and 6) of the wedge press 20.

As the humid mass passes through the wedge press 20, at least a portion of the liquid in the humid mass is removed therefrom to result in a liquid filtrate and solid cake (or waste solid). In the illustrated example, the solid cake exits the wedge press 20 through a wedge press outlet 38 (see FIGS. 5 and 6). The solid cake passes through the wedge press outlet 38 and through the cake discharge unit 16 for removal from the liquid extraction machine 10. The liquid filtrate removed from the humid mass exits the housing 12 through the filtrate discharge 18. The filtrate discharge 18 is fluidly connected to the interior space 30 of the housing 12 located outside of the wedge press 20 as discussed in more detail below. It is contemplated that the filtrate discharge 18 could merely be an outlet spout of the housing 12.

In the illustrated example, the humid mass passes through the wedge press 20 within the liquid extraction machine 10. The wedge press 20 forms a path therethrough from the wedge press inlet 36 to the wedge press outlet 38. In the illustrated example, the wedge press inlet 36 is located below the wedge press outlet 38, such that the humid mass travels upward. However, it is contemplated that the wedge press inlet 36 can be located above the wedge press outlet 38, such that the humid mass travels downward. Nevertheless, in any configuration, because the filter screens 22 are non-parallel, the humid mass travels from a path with a larger cross-sectional area where the filter screens 22 are furthest apart adjacent the wedge press inlet 36 to a path with a smaller cross-sectional area where the filter screens 22 are closest adjacent the wedge press outlet 38. In the illustrated embodiment, the filter screens 22 are furthest apart at a bottom of the wedge press 20 and closest at a top of the wedge press 20.

The illustrated wedge press 20 is formed from a pair of non-parallel structures to force the humid mass from an area of the path with the larger cross-sectional area to an area of the path with the smaller cross-sectional area. The wedge press 20 includes a first side wheel assembly 40, a first side retaining plate 42, a first side outer seal 44, a wedge shaped center seal assembly 46, a second side outer seal 48, a second side retaining plate 50 and a second side wheel assembly 52. In the illustrated example, separate motor assemblies 24 are each connected to one of the wheel assemblies 40, 52 to rotate the wheel assemblies 40, 52. In the illustrated example, the first side wheel assembly 40 and the second side wheel assembly 52 are mirror images of each other about the wedge shaped center seal assembly 46, the first side retaining plate 42 and the second side retaining plate 50 are mirror images of each other about the wedge shaped center seal assembly 46, and the first side outer seal 44 and the second side outer seal 48 are mirror images of each other about the wedge shaped center seal assembly 46.

In the illustrated embodiment, the first side wheel assembly 40 and the second side wheel assembly 52 form an outer periphery of a path through the wedge press 20. Since the first side wheel assembly 40 and the second side wheel assembly 52 are mirror images of each other about the wedge shaped center seal assembly 46, only the first side wheel assembly 40 will be described, with the understanding that the second side wheel assembly 52 is a mirror image thereof.

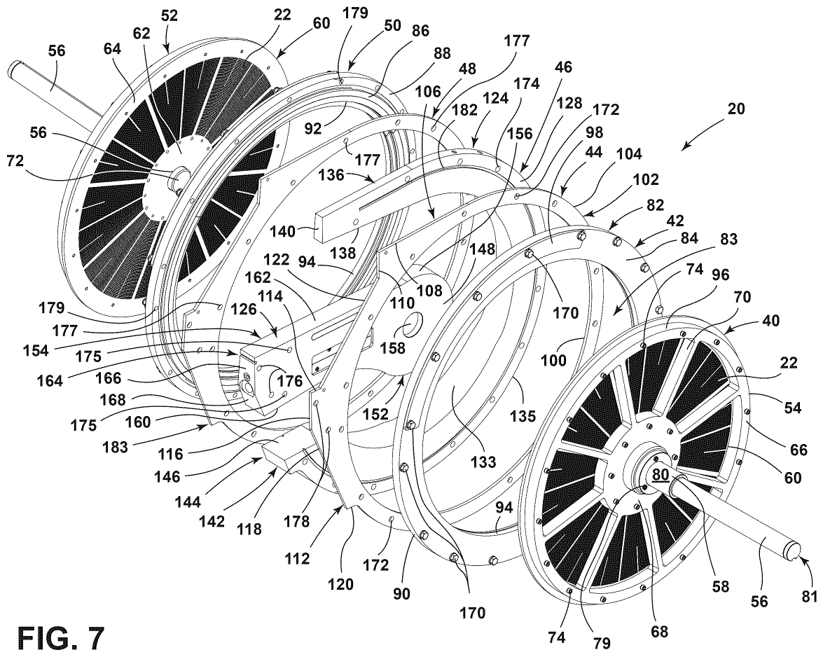

The illustrated first side wheel assembly 40 includes the filter screen 22, a support wheel 54, an axle 56 and an axle sleeve 58. The filter screen 22 can be a plate 60 that includes openings therethrough for allowing the filtrate in the humid mass to pass therethrough. The openings can be any shape, for example, circular openings, openings of any other shape or elongated slots. The plate 60 can also include a solid center hub 62 and a solid rim 64 (which is shown in the second side wheel assembly 52 in FIG. 7). It is further contemplated that the plate 60 could include a plurality of struts between the solid center hub 62 and the solid rim 64, although such struts are not required.

In the illustrated example, the support wheel 54 of the first side wheel assembly 40 supports the filter screen 22. The support wheel 54 includes a circular rim 66, a central hub 68 and a plurality of spokes 70 extending between the circular rim 66 and the central hub 68. A plurality of fasteners 74 extend through the circular rim 66 and the central hub 68 of the support wheel 54 and into the solid rim 64 and the solid center hub 62 of the plate 60, respectively, to fix the plate 60 to the support wheel 54. The support wheel 54 supports the plate 60 and prevents the plate 60 from deforming due to pressure within the wedge press 20 as the humid mass passes through the wedge press 20 and presses against the plate 60 to allow the liquid filtrate to pass through the plate 60. The plate 60 fits between the first side retaining plate 42 and the wedge shaped center seal assembly 46 as outlined below. The central hub 68 has an outwardly extending cylinder 76 that engages with the axle sleeve 58.

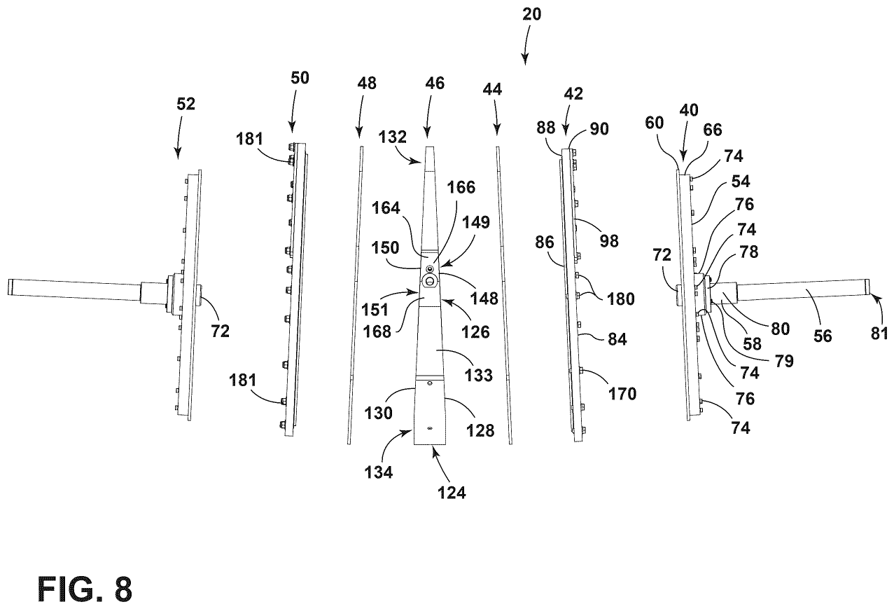

The illustrated axle sleeve 58 of the first side wheel assembly 40 assists in supporting the axle 56 to allow the axle 56 to rotate the first side wheel assembly 40. The axle sleeve 58 includes a flat base portion 78 and a cylindrical portion 80. The flat base portion 78 rests on the outwardly extending cylinder 76 of the central hub 68 of the support wheel 54 and fasteners 79 extend through the flat base portion 78 and into the outwardly extending cylinder 76 of the central hub 68 to connect the axle sleeve 58 to the support wheel 54. The axle 56 extends through the cylindrical portion 80 of the axle sleeve 58, through the outwardly extending cylinder 76 of the central hub 68 of the support wheel 54, and through a central opening in the solid center hub 62 of the plate 60. The axle 56 of the second side wheel assembly 52 has an inner end 72 that is shown protruding from the plate 60 of the second side wheel assembly 52 in FIG. 7, with the axle 56 of the first side wheel assembly 40 protruding from the plate 60 of the first side wheel assembly 40 in the same manner (see FIG. 8). The axle 56 includes a keyed outer end 81 to allow the at least one motor assembly 24 to be able to engage with and rotate the axle 56.

In the illustrated example, the first side retaining plate 42 connects the first side wheel assembly 40 to the wedge shaped center seal assembly 46 and maintains the plate 60 of the first side wheel assembly 40 in position within the wedge press 20. As shown in FIGS. 7 and 8, the first side retaining plate 42 comprises a round plate 82 having an outside face 84 and an inside face 86.

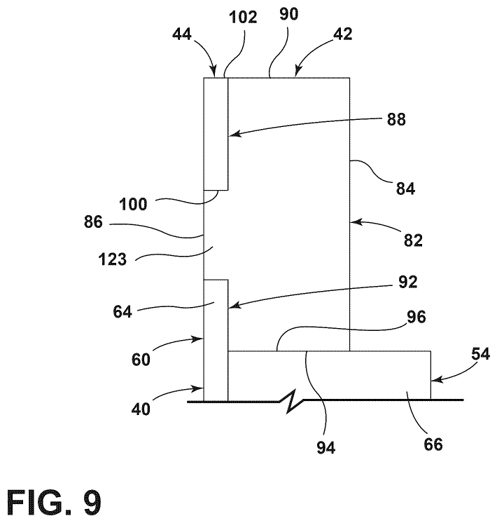

An outer step 88 is located at a junction of the inside face 86 and an outer peripheral surface 90 of the round plate 82. An inner step 92 is located at a junction of the inside face 86 and an inner peripheral surface 94 of the round plate 82. The inner step 92 is configured to receive an outer portion of the solid rim 64 of the plate 60 as shown in FIG. 9. An outer peripheral surface 96 of the circular rim 66 of the support wheel 54 abuts against the inner peripheral surface 94 of the round plate 82 as shown in FIG. 9. The outer step 88 is configured to receive the first side outer seal 44 as shown in FIG. 9. It is contemplated that the round plate 82 could include an arcuate reinforced bar 98 adjacent a front, top thereof as shown in FIGS. 5 and 7 to provide for additional structural support for this area of the round plate 82.

The illustrated first side outer seal 44 is located between the first side retaining plate 42 and the wedge shaped center seal assembly 46 and creates a seal between these parts of the wedge press 20. The first side outer seal 44 is a thin sheet of material having a circular opening 100 therein. An outer edge 102 of the first side outer seal 44 includes a rear circular portion 104, a top front projection 106 with a horizontal edge 108 and a vertical edge 110, and a bottom front projection 112 having a top horizontal edge 114, a front vertical edge 116, a lower angled edge 118 and a bottom horizontal edge 120. An upper angled edge 122 extends between the vertical edge 110 of the top front projection 106 and the top horizontal edge 114 of the bottom front projection 112. As discussed above, the first side outer seal 44 sits within the outer step 88 of the round plate 82 of the first side retaining plate 42, with the circular opening 100 encircling a projection 123 of the round plate 82 between the outer step 88 and the inner step 92 (see FIG. 9).

In the illustrated example, the center seal assembly 46 is wedge shaped and provides the shape for the wedge press 20. The wedge shaped center seal assembly 46 includes an outer C-shaped portion 124 and an inner seal portion 126. The outer C-shaped portion 124 includes a first side face 128 and a second side face 130. As shown in FIGS. 6-8, the first side face 128 and the second side face 130 are substantially planar, but not parallel, with an upper area 132 of the first side face 128 and the second side face 130 closer together than a bottom area 134 of the first side face 128 and the second side face 130. The outer C-shaped portion 124 further includes an inner circular surface 133 and an outer circular surface 135. A top part 136 of the outer C-shaped portion 124 is substantially straight with a straight inner surface area 138 and a straight outer surface end 140. A bottom part 142 of the outer C-shaped portion 124 includes a lip 144 with a top flat surface 146 that intersects with the inner circular surface 133. The inner circular surface 133 defines an outer periphery of the path of the humid mass through the wedge press 20.

The illustrated inner seal portion 126 includes a first side face 148 and a second side face 150. As shown in FIGS. 6-8, the first side face 148 and the second side face 150 are substantially planar, but not parallel, with an upper area 149 of the first side face 148 and the second side face 150 closer together than a bottom area 151 of the first side face 148 and the second side face 150.

Moreover, the first side face 148 of the inner seal portion 126 is substantially parallel with the first side face 128 of the outer C-shaped portion 124. Likewise, the second side face 150 of the inner seal portion 126 is substantially parallel with the second side face 130 of the outer C-shaped portion 124.

In the illustrated example, the illustrated inner seal portion 126 of the wedge shaped center seal assembly 46 of the wedge press 20 defines an inner surface of the path of the humid mass through the wedge press 20. The inner seal portion 126 includes a central circular segment 152 and a straight portion 154 that extends forwardly from the central circular segment 152. The central circular segment 152 is located in the center of the wedge press 20 and includes an outer circular surface 156 defining a circular portion of the inner surface of the path of the humid mass through the wedge press 20. The central circular segment 152 also includes a pair of axle receiving openings 158 in the first side face 148 and the second side face 150 of the inner seal portion 126, although it is contemplated that the axle receiving openings 158 could be a continuous opening. The axle receiving openings 158 receive the inner end 72 of the axle 56 therein. It is contemplated that the axle receiving openings 158 could include bearings or similar structures therein to allow the inner end 72 of the axle 56 to easily rotate therein.

The illustrated straight portion 154 of the inner seal portion 126 of the wedge shaped center seal assembly 46 of the wedge press 20 defines an entrance area and exit area of the inner surface of the path of the humid mass through the wedge press 20. The straight portion 154 includes a flat lower surface 160 that transitions to the outer circular surface 156 of the central circular segment 152 at the entrance area and a flat upper surface 162 that transitions from the outer circular surface 156 of the central circular segment 152 towards the exit area. A front surface edge 164 of the straight portion 154 includes a horizontal part 166 and an angled part 168.

In the illustrated example, the wedge press 20 is constructed by positioning the first side wheel assembly 40 between the wedge shaped center seal assembly 46 and the first side retaining plate 42. Likewise, the second side wheel assembly 52 is positioned between the wedge shaped center seal assembly 46 and the second side retaining plate 50. Since the wedge press 20 is vertically symmetrical about a center of the wedge press 20, only the assembly of the first side of the wedge press 20 will be discussed, with the understanding that the second side of the wedge press 20 is assembled in the same manner. To begin assembly, the axle 56 of the first side wheel assembly 40 is inserted through a central opening 83 in the round plate 82 of the first side retaining plate 42 from an inside thereof. The first side wheel assembly 40 is then abutted against the first side retaining plate 42 as illustrated in FIG. 9 with the solid rim 64 of the plate 60 being located in the inner step 92 of the first side retaining plate 42 and the outer peripheral surface 96 of the support wheel 54 substantially abutting the inner peripheral surface 94 of the round plate 82 of the first side retaining plate 42.

The first side wheel assembly 40 is able to freely rotate relative to the first side retaining plate 42. The first side outer seal 44 is also positioned in the outer step 88 of the round plate 82 of the first side retaining plate 42 (either before or after the first side wheel assembly 40 is engaged with the first side retaining plate 42).

Once the first side wheel assembly 40 and the first side outer seal 44 are positioned in the first side retaining plate 42 and the second side wheel assembly 52 and the second side outer seal 48 are positioned in the second side retaining plate 50, the wedge press 20 is ready for final assembly. As shown in FIGS. 5-7, fasteners 170 are inserted through an opening in the round plate 82 and the arcuate reinforced bar 98 of the first side retaining plate 42 in a circular manner, through corresponding holes 172 in the first side outer seal 44, through openings 174 in the outer C-shaped portion 124 and openings 175 in the straight portion 154 of the inner seal portion 126 of the wedge shaped center seal assembly 46, through corresponding holes 177 in the second side outer seal 48, and through openings 179 in the second side retaining plate 50. The fasteners 170 are then tightened using nuts 181 on an outer face of the second side retaining plate 50. However, it is contemplated that the fasteners 170 could be inserted through the second side retaining plate 50 and the nuts 181 could be adjacent the first side retaining plate 42. As shown in FIG. 7, the first side face 128 and the second side face 130 of the outer C-shaped portion 124 of the wedge shaped center seal assembly 46 can include an arcuate ledge 182 that surrounds the solid rim 64 of the plate 60 to assist in sealing the filter screen 22 within the wedge press 20.

In the illustrated example, the wedge press 20 includes additional structural support at the wedge press inlet 36. As shown in FIGS. 5 and 6, support blocks 184 are positioned on either side of the wedge press inlet 36. The support blocks 184 are positioned on outer surfaces of the bottom front projection 112 of the first side outer seal 44 and a bottom front projection 183 of the second side outer seal 48. Fasteners 180 are inserted through holes 178 in the bottom front projection 112 of the first side outer seal 44, through openings in the support block 184 adjacent the first side outer seal 44, through holes 176 in the straight portion 154 of the inner seal portion 126 of the wedge press 20, through openings in the support block 184 adjacent the second side outer seal 48, and through holes 185 in the bottom front projection 183 of the second side outer seal 48. The fasteners 180 are then tightened using nuts 181 on an outer face of the support block 184. However, it is contemplated that the fasteners 180 could be in the opposite direction with the nuts 181 on the opposite as that illustrated.

The illustrated wedge press 20 provides a path therethrough for the humid mass to cause the liquid filtrate to be removed from the humid mass through pressure. The path of the humid mass through the wedge press 20 is in a C-shaped path from the wedge press inlet 36 to the wedge press outlet 38. A cross-sectional periphery of the C-shaped path as the humid mass moves from the wedge press inlet 36 to the wedge press outlet 38 is defined at an inner side by the flat lower surface 160 of the straight portion 154 of the inner seal portion 126 of the wedge shaped center seal assembly 46, then the outer circular surface 156 of the central circular segment 152 of the wedge shaped center seal assembly 46, and then the flat upper surface 162 of the straight portion 154 of the inner seal portion 126 of the wedge shaped center seal assembly 46.

The illustrated sides of periphery of the C-shaped path as the humid mass moves from the wedge press inlet 36 to the wedge press outlet 38 is defined by the filter screens 22. As shown in FIG. 6, because the filter screens 22 are non-parallel, the humid mass travels from a path with a larger cross-sectional area because the filter screens 22 are a larger distance apart 500 at a bottom of the wedge press 20 to a smaller cross-sectional area because the filter screens 22 are a smaller distance apart 502 at a top of the wedge press 20. The filter screens 22 therefore are at an angle a to each other than is smaller than 180°. In the illustrated example, the outer side of the periphery of the C-shaped path as the humid mass moves from the wedge press inlet 36 to the wedge press outlet 38 is defined by the inner circular surface 133 of the outer C-shaped portion 124 of the wedge shaped center seal assembly 46.

In the illustrated example, the liquid filtrate is pushed through the filter screens 22 through a combination of the pressure of the humid mass entering the wedge press inlet 36 and the change in the cross-sectional area of the path of the humid mass through the wedge press 20, which increases the pressure of the humid mass as it passes through the wedge press 20. Moreover, the pressure of the humid mass passing through the wedge press 20 can be increased through use of the cake discharge unit 16 at the wedge press outlet 38. The cake discharge unit 16 can include a pair of oppositely facing pressure plate assemblies 300 in the cake discharge unit 16. The oppositely facing pressure plate assemblies 300 include actuators 302 that force outlet walls within an outlet area 306 of the cake discharge unit 16 toward each other (e.g., in a parallel fashion with a smaller outlet area than inlet area) as is well known to those skilled in the art. The oppositely facing pressure plate assemblies 300 can be selectively activated or activated in a desired manner to control the pressure of the humid mass within the wedge press 20 (e.g., adjusting the outlet area within the cake discharge unit 16 in a dynamic fashion to ensure that the pressure within the wedge press 20 is constant at any particular area of the path of the humid mass through the wedge press 20). The cake discharge unit 16 can also include an exit door 304 that can be selectively opened and closed.

Since the illustrated axles 56 of the first side wheel assembly 40 and the second side wheel assembly 52 are not colinear, the liquid extraction machine 10 includes a motor assembly 24 for each axle 56 of the first side wheel assembly 40 and the second side wheel assembly 52. Each motor assembly 24 includes a motor 202 for rotating each of the axles 56, with an output of the motor 202 engaged with an angled coupler 206 that is engaged with one of the axles 56 (e.g., by engagement with the keyed outer end 81 of the axle 56). Since each of the first side wheel assembly 40 and the second side wheel assembly 52 have individual motor assemblies 24, each of the filter screens 22 of the first side wheel assembly 40 and the second side wheel assembly 52 can be individually controlled. It is contemplated that the axles 56 could directly connect to the output of the motors 202 without using an angled coupler 206. A motor support bracket 204 connected to the base 26 of the housing 12 of the liquid extraction machine 10 to support includes a support plate 210 for supporting the angled coupler 206 and the motor 202. As illustrated in FIGS. 1 and 2, an inner seal plate 212 and an outer seal plate 208 can be located between the angled coupler 206 and the base 26 of the housing 12 of the liquid extraction machine 10 to seal the connection between the angled coupler 206 and the axle 56.

It is to be understood that variations and modifications can be made on the aforementioned structure without departing from the concepts of the present invention, and further it is to be understood that such concepts are intended to be covered herein unless expressly stated otherwise. Moreover, it is to be understood that such concepts are intended to be covered by the following claims unless these claims by their language expressly state otherwise.

We claim:

1. A liquid extraction assembly for extracting liquid from a mass comprising:
a housing having an inlet and an outlet;
the housing further including a path between the inlet and the outlet;
the housing being configured to have the mass forced into the inlet to move the mass from the inlet to the outlet;
the housing including a pair of rotating screens adjacent opposite sides of the path, the pair of rotating screens defining opposite walls of the path;
the pair of rotating screens including a plurality of openings located at the path;
wherein pressure from the mass forced into the inlet presses the mass against the openings of the pair of rotating screens to thereby force at least a portion of liquid in the mass to pass through the openings of the pair of rotating screens;
wherein the pair of rotating screens are non-parallel such that a cross-sectional area of the path between the pair of rotating screens is larger adjacent the inlet than adjacent the outlet.

2. The liquid extraction assembly of claim 1, wherein:
the inlet is located below the outlet.

3. The liquid extraction assembly of claim 1, wherein:
a center seal surrounds at least a portion of a perimeter of the path.

4. The liquid extraction assembly of claim 3, wherein:
the center seal includes a pair of non-parallel faces, with each of the pair of non-parallel faces being parallel with one of the pair of rotating screens.

5. The liquid extraction assembly of claim 1, further including:
a pair of motor assemblies, each of the pair of motor assemblies rotating one of the pair of rotating screens such that each of the rotating screens can rotate at a different speed.

6. A method of extracting liquid from a mass comprising:
providing a housing having an inlet and an outlet;
providing a path between the inlet and the outlet;
forcing the mass into the inlet of the housing to move the mass from the inlet to the outlet;
providing the housing with a pair of rotating screens adjacent the path, with the pair of rotating screens defining opposite walls of the path, and with the pair of rotating screens including a plurality of openings located at the path;
rotating the pair of rotating screens;
pressing the mass against the openings of the pair of rotating screens to thereby force at least a portion of liquid in the mass to pass through the openings of the pair of rotating screens; and
positioning the pair of rotating screens non-parallel to each other such that a cross-sectional area of the path between the pair of rotating screens is larger adjacent the inlet than adjacent the outlet.

7. The method of claim 6, further including:
locating the inlet below the outlet.

8. The method of claim 6, wherein:
a center seal surrounds at least a portion of a perimeter of the path.

9. The method of claim 8, wherein:
the center seal includes a pair of non-parallel faces, with each of the pair of non-parallel faces being parallel with one of the pair of rotating screens.

10. The method of claim 6, further including:
a pair of motor assemblies, each of the pair of motor assemblies rotating one of the pair of rotating screens such that each of the pair of rotating screens can rotate at a different speed.

11. A liquid extraction assembly for extracting liquid from a mass comprising:
a housing having an inlet and an outlet;
the housing further including a path between the inlet and the outlet;
the housing being configured to have the mass forced into the inlet to move the mass from the inlet to the outlet;
the housing including a pair of rotating screens adjacent opposite sides of the path, the pair of rotating screens defining opposite walls of the path;
the pair of rotating screens including a plurality of openings located at the path;
wherein pressure from the mass forced into the inlet presses the mass against the openings of the pair of rotating screens to thereby force at least a portion of liquid in the mass to pass through the openings of the pair of rotating screens;
wherein each of the pair of rotating screens has a separate motor assembly for rotating one of the pair of rotating screens associated therewith such that each of the pair of rotating screens can rotate at a different speed.
